(19) United States
(12) Patent Application Publication
(10) Pub. No.: US 2005/0200615 A1
(43) Pub. Date: Sep. 15, 2005

(54) [COLOR MANAGEMENT STRUCTURE FOR PANEL DISPLAY AND METHOD THEREOF]

(76) Inventor: Che-Li Lin, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,467

(22) Filed: May 7, 2004

(30) Foreign Application Priority Data
Mar. 9, 2004 (TW) 93106119

(51) Int. Cl. G09G 3/36

(52) U.S. Cl. 345/204

(57) ABSTRACT

A color management structure for a panel display is provided. It comprises: a display array unit; a plurality of gate drivers; a plurality of source drivers, the plurality of gate drivers and the plurality of source drivers driving the display array unit to display an image; and a timing sequence control unit, the timing sequence control unit outputting a plurality of signals to the plurality of gate drivers and the plurality of source drivers to drive the display array unit, the timing sequence control unit outputting a clock signal and a color management data to the plurality of source drivers.

### CROSS REFERENCE TO RELATED APPLICATIONS

This application claims the priority benefit of Taiwan application serial no. 93106119, filed Mar. 9, 2004.

### BACKGROUND OF INVENTION

1. Field of the Invention

This invention generally relates to display device, and more particularly to a color management structure for panel display and method thereof.

2. Description of Related Art

In the recent years, the display technology has significantly developed. A significant portion of the traditional CRT displays has been replaced by the panel displays. One of the most common panel displays is the thin-film transistor liquid crystal display (TFT-LCD). In addition, the plasma display and the organic light emitting diode (OLED) display become more and more common.

The display part of the panel display includes the pixel array. The pixel array is an ordinary matrix array, and the pixel array is driven by a driver. The driver drives the corresponding pixels based on the arrayed image data. The pixels display the specific colors at the specific time under control by the driver. However, the color of the pixel is still required to be corrected (such as gamma curve correction) in order to match the ideal color for the human eyes. The traditional color correction is described as follows by using the TFT LCD as the example.

FIG. 1 is the block diagram of the source driver of the traditional TFT LCD device. The TFT LCD device uses the source driver and the gate driver to drive the pixels. The color correction data are sent to the source driver to correct the displayed color. The source driver as shown in FIG. 1 generally includes the shift register 100, the line latch 102, the level shifter 104, the digital to analog converter (DAC) 106, the output buffer 108, the signal receiver 110, and the data register 112. The DAC 106 receives the voltage levels VGMA1-VGMA14 of the parallel inputted gamma correction curves. The signal receiver 110 receives the input signal such as RSDS related signals. The output buffer 108 outputs the signals Y1, Y2, . . . to drive the pixels to display. The traditional source driver in FIG. 1 is well known to one skilled in the art and not further described here.

The basic structure of the traditional LCD device is shown in FIG. 2. It includes a TFT LCD pixel array 120 to display the image. The rows and columns of the pixel array 120 are driven by a plurality of source drivers 122 and a plurality of gate drivers 124. The power supply unit 130, such as the DC/DC converter, supplies the voltage to the source drivers 122 and the gate drivers 124. In addition, the Application Specific IC (ASIC) 126 generates the proper clock signal and the color data based on the input data from the connector 128 to correspond to the data signal outputted to the source drivers 122 and the gate drivers 124 (shown in arrow). The required data signal is known to the skill in the art and is not further described here. Generally, the ASIC chip 126 includes the receiver 126a, the RSDS/TTL transmitter 126b, and the timing sequence controller 126c.

In addition, the traditional LCD device also includes gamma correction unit 132 to parallel output a plurality of gamma curve color correction voltages to each source driver 122 to correct the color of the pixel.

The voltage required by the gamma curve is provided by the voltage divider via resistors on the system circuit board. In addition, regarding to the application on television, in order to have better color performance or color management, each of red, green, and blue colors would have a gamma curve. It is so-called 3-gamma design. To provide 3 gamma curves, the resistors for the voltage dividers and the capacitors for stabilizing the voltage levels increase by three times, which increases the production cost. Further, because of the increasing number of the drivers due to a large number of the bits and the purpose of better gamma fitting, the number of the gamma data increases from 10 to 14 or more. If the 3-gamma design is also taken into account, the size of the circuit board must become greatly larger. The cost and weight of the system significantly increase. In addition, the gamma data cannot be adjusted based on the traditional design. However, the resistors on the system circuit board have to be adjusted due to the different brightness and the different liquid crystal. Hence, it takes longer time to adjust the design if this so-called resistor-on-PCB design is used, which causes the delay of the development schedule.

### SUMMARY OF INVENTION

At least an object of the present invention is to provide a color management structure for the display device, which does not require the gamma correction unit to provide the color management data for the source driver. The timing sequence control unit can provide the color management data for the source drivers. The color management data can be used after it is decoded and converted by the source driver. Hence, it does not have the resistors required in the voltage dividers of traditional gamma correction unit, which reduces the production cost and the weight of the device.

The present invention provides a color management structure for a panel display, comprising a display array unit; a plurality of gate drivers, a plurality of source drivers, and a timing sequence control unit. The plurality of gate drivers and the plurality of source drivers drive the display array unit to display an image. The timing sequence control unit outputs a plurality of signals to the plurality of gate drivers and the plurality of source drivers to drive the display array unit. The timing sequence control unit outputs a clock signal and a color management data to the plurality of source drivers.

The present invention also provides another color management structure for a panel display, comprising: a display array unit; a plurality of gate drivers; a plurality of source drivers; a timing sequence control unit; and a color management interface system. The plurality of gate drivers and the plurality of source drivers drive the display array unit to display an image. The timing sequence control unit outputs a plurality of signals to the gate drivers and the source drivers to drive the display array unit. The timing sequence control unit outputs a clock signal. The color management interface system, coupled to the timing sequence control unit and the plurality of source drivers, generates a color management data to the source drivers.

Another object of the present invention is to provide a source driver for the panel display to drive a display array unit. The source driver can receive the serial color management data and convert it to a plurality of parallel color management data to perform color management.

The present invention provides a source driver for driving a display array unit of a panel display. The source driver comprising: a source drive circuit to drive the display array unit; and a programmable data interface to receive a color management data and a clock signal, and parallel outputting a plurality of color voltage level signals to the source drive circuit.

Still another object of the present invention is to provide a color management method, which does not require the gamma correction unit to provide the color management data for the source driver. Because it can reduce the resistors required in the voltage dividers of traditional gamma correction unit, it reduces the production cost and the weight of the device.

The present invention provides a color management method for a panel display. The panel display including a display array unit, a plurality of drivers, and a timing sequence control unit, the timing sequence control unit outputting a plurality of signals to the plurality of drivers to drive the display array unit. The color management method comprises the timing sequence control unit generating a serial color management data based on a clock signal. Also and, the serial color management data are converted to a plurality of parallel analog color data signals. The plurality of parallel analog color data signals are input to the plurality of drivers to correct a color of a pixel.

The present invention provides a panel display comprising: a display array unit; a plurality of drivers driving the display array unit to display an image; and a timing sequence control unit. The timing sequence control unit outputs a plurality of signals to the drivers to drive the display array unit. The timing sequence control unit outputs a clock signal and a color management data to the plurality of drivers.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is the block diagram of the traditional source driver.

FIG. 2 is the structural diagram of the traditional LCD device.

FIG. 3 is the block diagram of the LCD device in accordance with a preferred embodiment of the present invention.

FIG. 4 is the block diagram of the ASIC chip of FIG. 3 in accordance with a preferred embodiment of the present invention.

FIG. 5 is the block diagram of the LCD device in accordance with a preferred embodiment of the present invention.

FIGS. 6 and 7 show the structural diagrams of the source driver in accordance with the present invention.

FIGS. 8 and 9 show the structural diagrams of the timing sequence control unit in accordance with the present invention.

### DETAILED DESCRIPTION

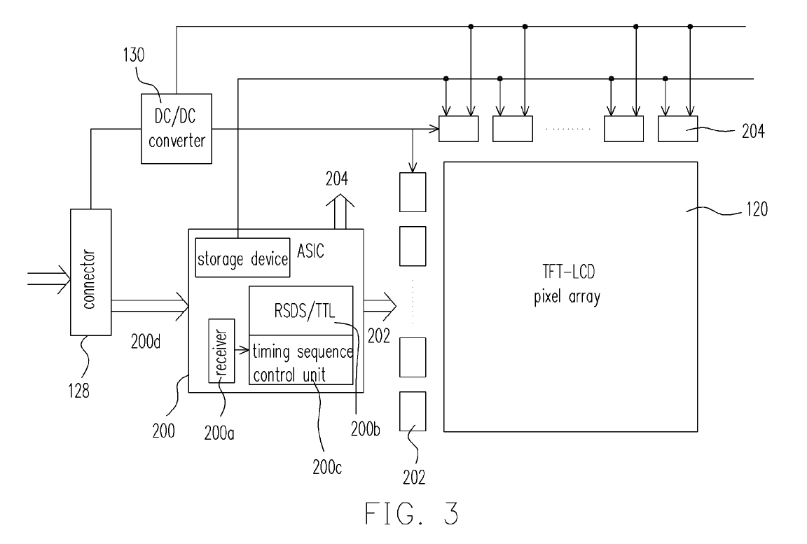

FIG. 3 is the block diagram of the LCD device in accordance with a preferred embodiment of the present invention. The LCD device includes a TFT LCD pixel array 120 to display the image. A plurality of source drivers 204 and a plurality of gate drivers 202 drive the corresponding pixels to display the image. DC/DC converter 130 provides the voltages to the drivers 202 and 204.

The present invention provides a novel ASIC chip 200. This ASIC chip 200 is so-called timing-sequence control unit. The ASIC chip 200 includes the receiver 200a, RDSD/ TTL transmitter 200b, the timing sequence controller 200c, and a storage device 200d. The storage device 200d stores the color management basic data. In addition, there is a programmable interface between the ASIC chip 200 and the source drivers 204. Hence, the ASIC chip 200 can output a plurality of signals to the gate drivers and source drivers 204 to drive the array unit. ASIC chip 200 also outputs a clock signal and a color management data to the source drivers 204.

The color management data is an adjustable or a programmable data. After the source drives 204 receive and process the data, the desired color management data such as gamma curve data can be obtained to drive the pixel to display the proper color.

In the embodiment of the present invention, because the color management data is stored in the storage device in a digital form and is converted via the interface to the color management data for the use of the source drivers 204, it does not have to implement the traditional gamma correction unit 132 on the system circuit, which can omit the use of a significant amount of resistors for voltage dividers.

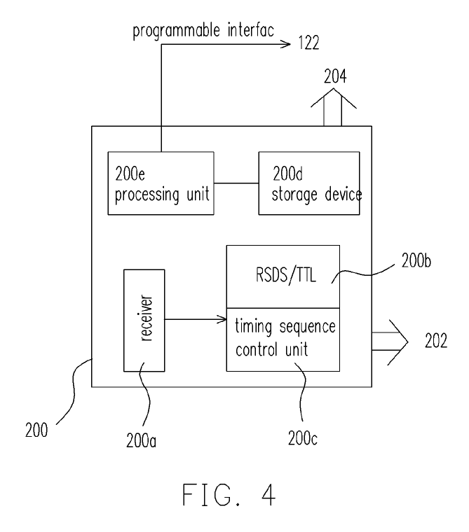

Based on the same principle, the ASIC chip 200 can have a variation as shown in FIG. 4. In FIG. 4, the ASIC chip 200 can provide the signal (as the arrow shown in FIG. 4) to the source drivers 204 and the gate drivers 202. ASIC chip 200 can also include the storage device 200d and the processing unit 200e. The processing unit 200e processes the data stored in the storage device 200d and sends the color management data, such as the gamma curve data, to the source drivers 204.

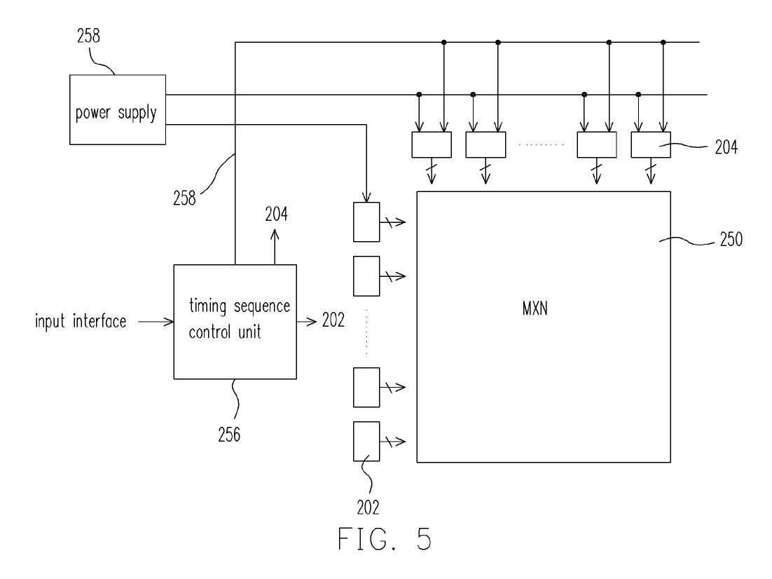

The above ASIC chip 200 can be called the timing sequence control unit. FIG. 5 is the block diagram of the LCD device in accordance with a preferred embodiment of the present invention. The panel display can be a panel 250 having M×N pixels. There are plurality of source drivers 204 and gate drivers 202 around the panel 250 to drive the corresponding pixels. The pixel array then displays the image. The power supply 258 provides the proper voltages to the source drivers 204 and the gate drivers 202.

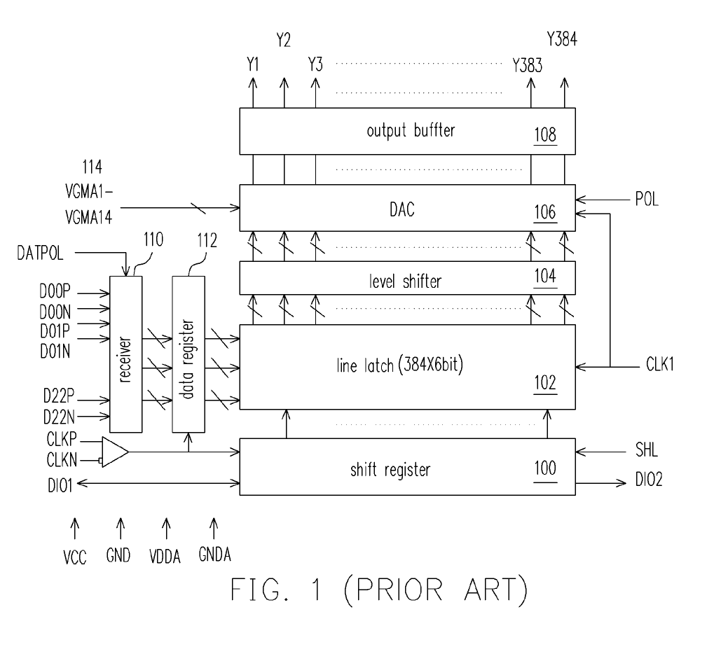

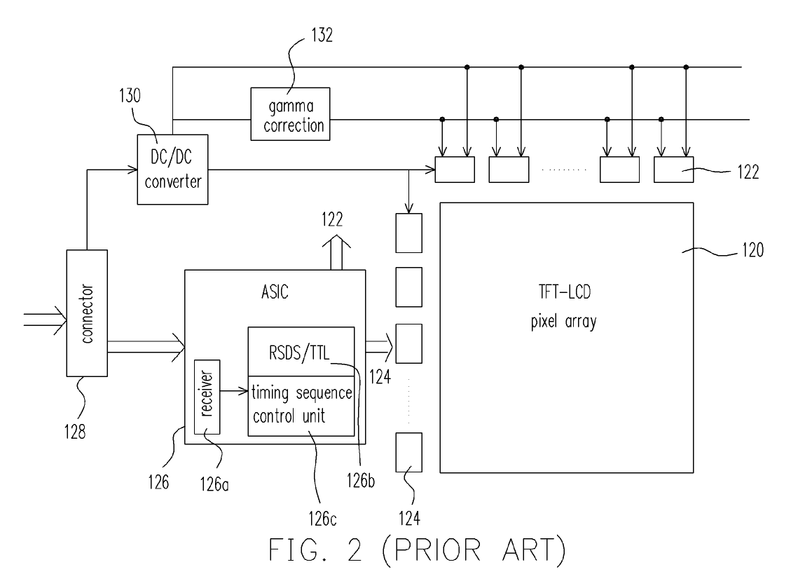

The LCD device also includes a timing sequence control unit 256. The timing sequence control unit 256 outputs a plurality of signals to the gate drivers 202 and source drivers 204 to drive the array unit. The timing sequence control unit 256 also outputs a clock signal and a color management data to the source drivers 204. The color management data includes the adjustable voltage value of the gamma curve or a series of voltages in a digital form. The serial color management data is decoded by the source drivers 204 to be the parallel analog color data voltage values. Those analog color data voltage values are for example the voltage values VGA1-VGA14 in FIG. 1.

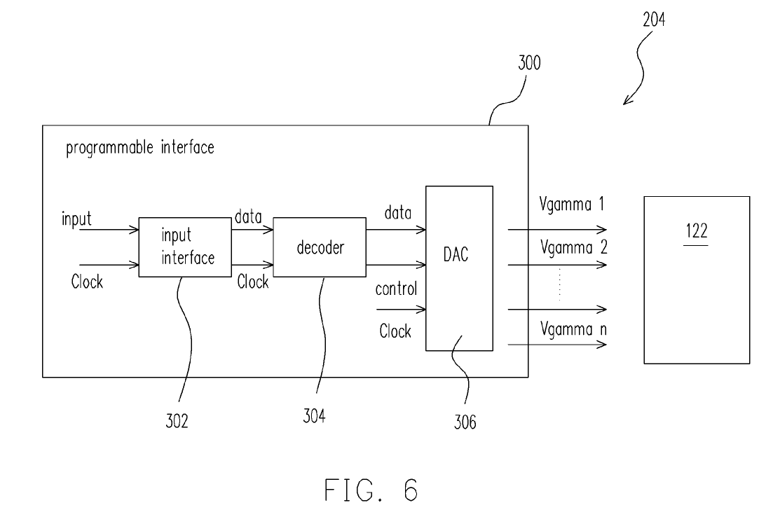

Regarding the design of the source driver 204, the programmable interface 300 and the traditional source driver 122 can be integrated to be the source driver 204 of the present invention as shown in FIG. 6. The programmable interface 300 can also be disposed between the timing sequence control unit 256 and the source driver 122.

In the embodiment of FIG. 6, the programmable interface 300 includes an input interface 302 to receive the programmable data from the timing sequence control unit 256 and a reference clock signal Clock. The input interface 302 translates the programmable data to the required format and outputs it to the decoder 304. The decoder 304 also receives the reference clock signal Clock and decodes the data to obtain the digital data and the control signal. The digital-to-analog converter (DAC) unit 306 receives the digital data, the control signal, and the reference clock signal Clock to convert the digital data to a plurality of parallel color management data such as Vgamma 1, Vgamma 2, . . . , Vgamma n. Those parallel color management data then are inputted into the traditional source driver 122.

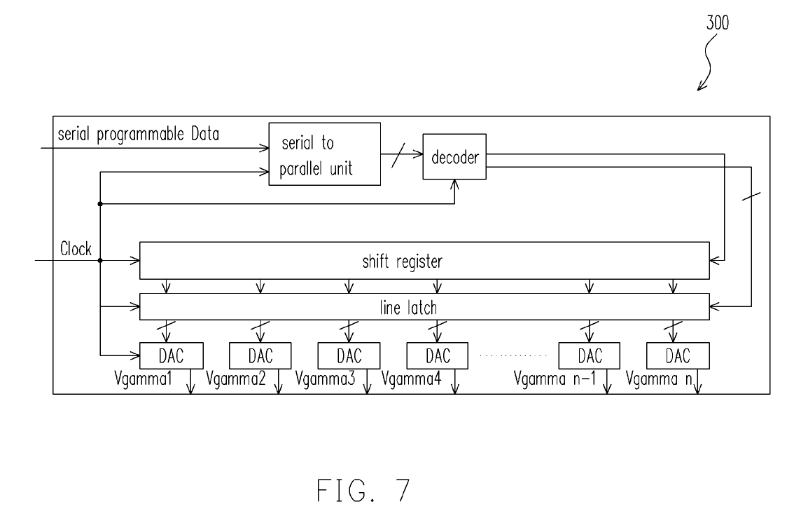

Regarding the programmable interface 300, it can have several variations. FIG. 7 shows the block diagram of the programmable interface 300 in accordance with the present invention. The serial programmable data via the serial-to-parallel input interface 302 is converted to a parallel data. The decoder 304 decodes the parallel data and uses the shift register, latch, and a plurality of DACs to obtain the analog color management data such as the voltage signals Vgamma 1, Vgamma 2, . . . , Vgamma n.

Therefore, the source driver of the present invention includes a source drive circuit to drive the display array unit, and a programmable data interface receiving a color management data and a clock signal to parallel output a plurality of color voltage level signals to the source drive circuit.

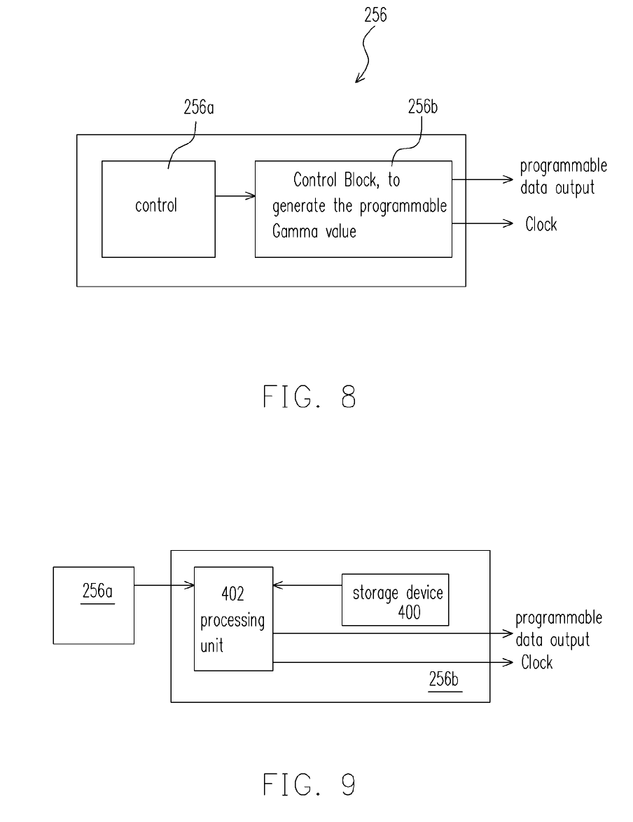

The timing sequence control unit 256 of the present invention can be integrated into the ASCI chip. The timing sequence control unit 256 as shown in FIG. 8 includes a traditional timing sequence controller 256a and a control block 256b. The timing sequence controller 256a is coupled to the control block 256b to generate the programmable color data such as gamma value. The control block 256b outputs the programmable data and the reference clock signal. The programmable and the reference clock signal can be sent to each source driver 204.

The above control block 256b as shown in FIG. 9 can include the processing unit 402 and the storage device 400.

The storage device 400 stores the color management reference or basic data. The processing unit 402 processes the color management reference or basic data and outputs the programmable data and the reference clock signal.

Although the color management interface system of the present invention is divided into two parts and these two parts are disposed in the timing sequence control unit and the source driver, the present invention is not limited to this arrangement. The color management interface system can be coupled to between the timing sequence control unit and the source driver to generate a color management data to the source drivers.

The present invention also provides a color management method for a panel display. The panel display includes a display array unit, a plurality of drivers, and a timing sequence control unit. The timing sequence control unit outputs a plurality of signals to the plurality of drivers to drive the display array unit. The color management method comprises generating a serial color management data from the timing sequence control unit, according to a clock signal. The serial color management data is converted to a plurality of parallel analog color data signals. The plurality of parallel analog color data signals are input to the plurality of drivers to correct a color of a pixel.

The LCD display device of the present invention does not require the traditional gamma correction unit to provide the color management data for the source driver. The timing sequence control unit can provide the color management data for the source drivers. The color management data can be used after it is decoded and converted by the source driver. Hence, it does not have the resistors required in the voltage dividers of traditional gamma correction unit, which reduces the production cost and the weight of the device.

The color management method is suitable not only for the TFT-LCD device, but also for other panel display to manage and correct the color.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A color management structure for a panel display, comprising:
a display array unit;
a plurality of gate drivers;
a plurality of source drivers, said plurality of gate drivers and said plurality of source drivers driving said display array unit to display an image; and
a timing sequence control unit, said timing sequence control unit outputting a plurality of signals to said plurality of gate drivers and said plurality of source drivers to drive said display array unit, said timing sequence control unit outputting a clock signal and a color management data to said plurality of source drivers.

2. The color management structure of claim 1, wherein said color management data is adjustable.

3. The color management structure of claim 1, wherein said panel display is a liquid crystal display.

4. The color management structure of claim 1, wherein said timing sequence control unit includes:
a timing controller receiving a system input and providing said clock signal; and
a color management control block, coupled to said timing controller, outputting said color management data and said clock signal to said plurality of source drivers, said color management data being adjustable.

5. The color management structure of claim 4, wherein said color management control block includes:
a storing unit storing a color management basic data; and
a processing unit receiving said color management basic data and an output of said timing controller and outputting said color management data and said clock signal.

6. The color management structure of claim 1, wherein each of said plurality of source drivers includes:
a source drive circuit to driving said display array unit; and
a programmable data interface receiving said color management data and said clock signal to parallel output a plurality of color voltage level signals to said source drive circuit.

7. The color management structure of claim 6, wherein said plurality of color voltage level signals includes a plurality of color gamma voltage level data.

8. The color management structure of claim 6, wherein said programmable data interface includes:
an input interface receiving said color management data and said clock signal and translating said color management data via a data format;
a decoder receiving said translated color management data and said clock signal and decoding said translated color management data, and outputting a decoded data and a control signal; and
a digital-to-analog converting unit receiving said decoded data, said control signal, and said clock signal, and parallel outputting said plurality of color voltage level signals.

9. The color management structure of claim 8, wherein said input interface converts a serial input signal into a plurality of parallel output signals based on said clock signal.

10. The color management structure of claim 8, wherein said digital-to-analog converting unit includes:
a shift register receiving an output of said decoder;
a latch receiving an output of said shift register and receiving said output of said decoder; and
a plurality of digital-to-analog converters, coupled to said latch, corresponding to said plurality of color voltage level signals respectively.

11. The color management structure of claim 1, wherein said timing sequence control unit is integrated into an application specified integrated circuit (ASIC).

12. A source driver for driving a display array unit of a panel display, said source driver comprising:
a source drive circuit to driving said display array unit; and
a programmable data interface receiving a color management data and a clock signal to parallel output a plurality of color voltage level signals to said source drive circuit.

13. The source driver of claim 12, wherein said plurality of color voltage level signals includes a plurality of color gamma voltage level data.

14. The source driver of claim 12, wherein said programmable data interface includes:
an input interface receiving said color management data and said clock signal and translating said color management data via a data format;
a decoder receiving said translated color management data and said clock signal and decoding said translated color management data, and outputting a decoded data and a control signal; and
a digital-to-analog converting unit receiving said decoded data, said control signal, and said clock signal, and parallel outputting said plurality of color voltage level signals.

15. The source driver of claim 14, wherein said input interface converts a serial input signal into a plurality of parallel output signals based on said clock signal.

16. The source driver of claim 14, wherein said digital-to-analog converting unit includes:
a shift register receiving an output of said decoder;
a latch receiving an output of said shift register and receiving said output of said decoder; and
a plurality of digital-to-analog converters, coupled to said latch, corresponding to said plurality of color voltage level signals respectively.

17. A color management structure for a panel display, comprising:
a display array unit;
a plurality of gate drivers;
a plurality of source drivers, said plurality of gate drivers and said plurality of source drivers driving said display array unit to display an image;
a timing sequence control unit, said timing sequence control unit outputting a plurality of signals to said plurality of gate drivers and said plurality of source drivers to drive said display array unit, said timing sequence control unit outputting a clock signal; and
a color management interface system, coupled to said timing sequence control unit and said plurality of source drivers, generating a color management data to said plurality of source drivers.

18. The color management structure of claim 17, wherein said color management interface system includes a color management control block in said timing sequence control unit and a color data converting unit in each of said plurality of source drivers to obtain a plurality of color voltage level signals for said plurality of source drivers.

19. A panel display comprising:
a display array unit;
a plurality of drivers driving said display array unit to display an image; and
a timing sequence control unit, said timing sequence control unit outputting a plurality of signals to said plurality of drivers to drive said display array unit, said timing sequence control unit outputting a clock signal and a color management data to said plurality of drivers.

20. The panel display of claim 19, wherein said color management data is a serial color management correction data.

21. A color management method for a panel display, said panel display including a display array unit, a plurality of drivers, and a timing sequence control unit, said timing sequence control unit outputting a plurality of signals to said plurality of drivers to drive said display array unit, said color management method comprising:
generating a serial color management data via said timing sequence control unit, according to a clock signal;
converting said serial color management data to a plurality of parallel analog color data signals; and
inputting said plurality of parallel analog color data signals to said plurality of drivers to correct a color of a pixel.
